(19) United States
(12) Patent Application Publication
(10) Pub. No.: US 2019/0005626 A1
(43) Pub. Date: Jan. 3, 2019

(54) SOCIAL-BASED IMAGE SETTING VALUE SHARING SYSTEM AND METHOD THEREFOR

(71) Applicant: Ki-won NAM, Seoul (KR)

(72) Inventor: Ki-won NAM, Seoul (KR)

(21) Appl. No.: 16/063,166

(22) PCT Filed: Dec. 14, 2016
(86) PCT No.: PCT/KR2016/014655

§ 371 Date: Jun. 15, 2018

(30) Foreign Application Priority Data
Dec. 16, 2015 (KR) 10-2015-0180034

(51) Int. Cl. G06T 5/00; G06T 5/20; G06F 17/30; G06Q 50/00

(52) U.S. Cl. CPC G06T 5/005; G06T 5/002; G06T 2207/30201; G06F 17/30165; G06Q 50/01; G06T 5/20

(57) ABSTRACT

The present invention relates to social-based image setting value sharing systems and methods. The present invention has an object to provide social-based image setting value sharing systems and methods, wherein a representative portrait image for each user and an image correction setting value thereof are registered in a server in advance and shared, and a portrait image of a user to be corrected through mutual information sharing among applications is tracked and automatically corrected according to the image correction setting value such that a user's desired image may be circulated.

### TECHNICAL FIELD

The present invention relates to social-based image setting value sharing systems and methods, and more particularly, to social-based image setting value sharing systems and methods, in which representative portrait images for each user and image correction setting values thereof are registered in a server in advance and shared, and a portrait image of a user to be corrected through mutual information sharing among applications is tracked and automatically corrected according to the image correction setting value, such that a user's desired image may be circulated.

### BACKGROUND ART

As is well known in the art, a mobile communication terminal includes a memory installed therein to store programs, data, data and the like, which are capable of performing various functions.

Due to an increase in a storage capacity of digital memory, the mobile communication terminal may be equipped with various functions other than the telephone call which is an original purpose thereof. In particular, in addition to the voice communication and text transmission service, recently released mobile communication terminals may allow a user to take his/her desired images using a camera mounted therein, and may support various functions such as transmission of image information and video call.

The mobile communication terminal capable of image communication may be classified into a built-in type camera in which a camera is installed and a detachable type camera in which a camera is separately provided and used by being inserted into a body of the terminal.

Conventionally, pictures taken by the mobile communication terminal are edited and transmitted through the following steps.

First, a user takes a picture using a camera unit installed in the mobile communication terminal, then selects a store button to store the taken picture or selects an edit button to edit the same.

When selecting the edit button, the taken picture is displayed on a screen of the terminal to edit. Then, the user inserts a memo using character input keys of a keypad, and stores the edited picture in the memory of the terminal.

Next, the user selects the stored picture to transmit it to an acquaintance, searches a phone number of the acquaintance, and inputs the phone number to transmit the picture.

However, in the conventional mobile communication terminal, it is inconvenient for the user to input individual characters by using the character input keys of the keypad in order to edit the captured picture.

In addition, the conventional mobile communication terminal allows only one user to edit the picture taken by the user, it takes a lot of time in edition of the picture, and it is substantially impossible to participate in the edition of the taken picture by two or more other people.

Further, when transmitting the edited picture using the conventional mobile communication terminal, the user needs to personally search and input the telephone number of the acquaintance to be transmitted, and thereby it is inconvenient.

Accordingly, in order to solve the above-described problems, Korean Patent Registration No. 10-628072 discloses a technique for allowing a plurality of users to participate in edition of the picture through text messages on the screen of their own terminals.

However, such a technique is merely a photo editing process performed on the screen of the terminal, and other persons have no edition right to perform editing on their own terminals, such that it also has the same problems as described above.

That is, when another person such as an acquaintance takes a portrait of a user, there is a case in which the user does not like his/her portrait image, or cannot confirm a state of the portrait image. In this case, even if his/her image is transmitted to another person through any path, there is no way to correct his/her image stored in the terminal of another person according to his/her will.

### DISCLOSURE

### Technical Problem

In consideration of the above-mentioned circumstances, it is an object of the present invention to provide social-based image setting value sharing systems and methods, in which representative portrait images for each user and image correction setting values thereof are registered in a server in advance and shared, and a portrait image of a user to be corrected through mutual information sharing among applications is tracked and automatically corrected according to the image correction setting value, such that a user's desired image may be circulated.

### Technical Solution

To achieve the above object, according to one aspect of the present invention, there is provided a social-based image setting value sharing system including: a setting user terminal (‘a first user terminal’) configured to register representative image information of a person and a personal image correction setting value in an image setting value relay server 10 and request the image setting value relay server 10 to share the image correction setting value; a user terminal to be set (‘a second user terminal’) configured to store an image file including a specific personal image, receive the image correction setting value for the specific personal image from the image setting value relay server 10 to determine whether the personal image is present in the second user terminal, and when the personal image is present, applies the image correction setting value to the personal image to perform correction thereon; and the image setting value relay server 10 configured to receive and register the representative image information of the person and the personal image correction setting value from the first user terminal, and automatically correct an image of a setting user, which is present in the second user terminal, based on the representative image according to the image correction setting value.

Preferably, the image correction setting value is a value of at least one selected from a face, body size or face tone, or nose or pupil size, eyebrow contrast, color value, and illuminance value.

Preferably, the first user terminal and the second user terminal respectively include: an image setting value sharing application 4 mounted therein to automatically access the image setting value relay server 10 to manage the representative images and the image correction setting values, search and determine whether the representative image is included in still picture or moving picture frames, and apply a specific image correction setting value to the searched representative image.

Preferably, the image setting value sharing application 4 is driven and operated in conjunction with a camera module.

Preferably, the image setting value sharing application 4 is configured to automatically identify whether the representative image is present in image files including all still picture files and moving picture files stored in a user terminal 2.

Preferably, the image setting value sharing application 4 includes: a communication means 20 configured to access the image setting value relay server 10 to perform communication therewith; a representative image manager 22 configured to manage a representative image set by a user; an image setting value manager 24 configured to manage an image correction setting value which is set according to a desire for correction of the user; a shared image setting value receiver 30 configured to receive and share an image correction setting value for a specific image of a third party among still pictures or moving pictures stored in the user terminal 2; an automatic image correction processor 32 configured to automatically correct the specific image of the third party by applying the image correction setting value received through the shared image setting value receiver 30; and a controller 38 which controls so as to transmit representative image data specified by the user and a specific setting value in which a correction is set for an image matching with or similar to the representative image to the image setting value relay server 10 and register therein, receive the specific representative image and the image correction setting value from the image setting value relay server 10 to scan images from the image files stored in the user terminal, and when the matched or similar image is present, apply the image correction setting value to the image and perform the correction.

Preferably, the image setting value sharing application 4 further includes: a camera linkage unit 26 configured to be automatically driven and operated in conjunction with an operation signal of a camera module.

Preferably, the image setting value sharing application 4 further includes: an unconfirmed image transmission unit 28 configured to, when identification for a specific person among images included in still picture files or moving picture files stored in the user terminal 2 is impossible or the image correction setting value is not present, automatically transmit the image to the image setting value relay server 10.

Preferably, the image setting value sharing application 4 further includes: a photo grouping registration unit 34 configured to select a specific acquaintance based on a personal telephone directory stored in the user terminal 2 and register by grouping into a photo group, and allow the image correction setting values to be shared only within the photo group.

Preferably, the image setting value sharing application 4 further includes: a screen output controller 36 which controls so as to insert a portrait image provided by the other party into a background image captured by a user in a capture mode and output on a screen, and insert his/her portrait image captured by the user into a background image provided by the other party and output on the screen in a pose mode.

Preferably, the user terminals 2 having the image setting value sharing application 4 installed therein mutually share the representative image registered in advance by each user with the image correction setting value through the image setting value sharing application 4.

Preferably, the representative image is a representative portrait image.

Preferably, the image setting value relay server 10 manages an object to be shared so that the image correction setting value registered in the image setting value relay server 10 through the first user terminal is shared by limiting to the second user terminal belonging to a photo group registered in the image setting value relay server 10 by the setting user.

Preferably, any one setting user is simultaneously registered in a plurality of photo groups.

Preferably, any one setting user specifies a specific user to be set 1:1 so as to change or correct his/her portrait image to a specific image.

Preferably, the image setting value relay server 10 includes: a communication means 40 configured to communicate with first and second user terminals 2; an application identification information manager 42 configured to identify a user upon access by allocating an application code; a representative image manager 44 configured to register and manage representative images for each application; an image setting value manager 46 configured to register and manage image correction setting values for each representative portrait image; an image search unit 50 configured to receive image files from a user, and search and determine whether a specific portrait image is registered; and a controller 56 which controls so as to automatically correct his/her portrait image which is registered by the user and stored in the user terminals 2, and includes the user in the image files to a pre-set specific setting value.

Preferably, the image setting value relay server 10 further includes: an information matching unit 48 configured to match application identification information, representative image information and image correction setting value information with each other.

Preferably, the image setting value relay server 10 further includes: an image identification information generator 52 configured to generate information for image identification by matching coordinate values of the portrait images included in the specific image file with the image correction setting value.

Preferably, the image setting value relay server 10 further includes: a grouping information registration unit 54 configured to select a specific acquaintance based on a personal telephone directory stored in a user terminal 2 and register the same by grouping into a photo group so that the image correction setting value is shared only within the photo group.

According to another aspect of the present invention, there is provided a social-based image setting value sharing method, including: a) receiving a representative portrait image and an image correction setting value from an image setting value sharing application 4 of a specific user, by an image setting value relay server 10; b) registering the representative portrait image and the image correction setting value of the user, by the image setting value relay server 10; c) outputting a specific image file through the image setting value sharing application 4; d) determining whether an image correction setting value for portrait image(s) included in the specific image file is present, by the image setting value sharing application 4; and e) when the image correction setting value is present, applying the image correction setting value to the portrait image to perform correction thereon, by the image setting value sharing application 4.

Preferably, after the step e), f) if the image correction setting value is not present, receiving an input of an image file identification request signal, by the image setting value sharing application 4; g) transmitting the image file to the image setting value relay server 10, by the image setting value sharing application 4; h) comparing a portrait image included in the image file with a pre-registered representative to identify a person, by the image setting value relay server 10; i) extracting image correction setting value information registered by matching with each portrait image, by the image setting value relay server 10; j) transmitting the extracted image correction setting value information to the image setting value sharing application 4; and k) automatically correcting the portrait image of the person, by the image setting value sharing application 4.

Preferably, in the step a), the image setting value sharing application 4 is automatically driven and operated in conjunction with a camera module.

Preferably, the step j) further includes: generating each portrait image data and coordinate information of the image, and image correction setting value information as a packet, by the image setting value relay server 10.

According to another aspect of the present invention, there is provided a social-based image setting value sharing method, including: a) receiving a new port group generation request signal from an image setting value sharing application 4 of a specific user, by an image setting value relay server 10; b) generating a new photo group by the image setting value relay server 10; c) receiving a representative portrait image and an image correction setting value from the image setting value sharing application 4 of the specific user; d) registering the representative portrait image and the image correction setting value of the user, by the image setting value relay server 10; e) transmitting the representative portrait image and the image correction setting value of the user to a user terminal specified by grouping, by the image setting value relay server 10; f) searching for a portrait image matched with the representative portrait image of the user, by the shared image setting value sharing application 4; and g) when a portrait image file matched with the representative portrait image is searched, applying the image correction setting value of the user to the portrait image to perform correction thereon, by the image setting value sharing application 4.

The social-based image setting value sharing method further includes: before the step a), receiving a new photo group generation key operation signal by the image setting value sharing application 4; calling and outputting a linked telephone directory by the image setting value sharing application 4; and specifying an object to be grouped by the image setting value sharing application 4.

Preferably, the step a) further includes: performing the correction so as to limit the new photo group to two persons and replace a specific portrait image with another portrait image.

According to another aspect of the present invention, there is provided a social-based image setting value sharing method, including: a) selecting a capture mode through an image setting value sharing application 4 by any user of two users located in different spaces at the same time, and selecting a pose mode by the other user; b) capturing a background image in conjunction with a camera by the image setting value sharing application 4; c) outputting the background image on a screen by the image setting value sharing application 4; d) receiving a background image file from the image setting value sharing application 4 of the user, and outputting the received background image file on the screen, by the image setting value sharing application 4 of the other user; e) capturing a portrait image and automatically inserting it into the background image, by the image setting value sharing application 4 of the other user; and f) sharing an image file in which the portrait image is inserted between the image setting value sharing applications 4.

### Advantageous Effects

The social-based image setting value sharing systems and methods according to the present invention may allow a user to automatically correct a portrait image in a picture captured by another person according to his/her own will and distribute the corrected image desired by the user, such that it is possible to provide confidence to the user and prevent an unfavorite image from being distributed to inhibit prejudice to the user. In addition, since the user may have a right to correct his/her own portrait in a picture of a stranger who does not know at all, privacy of the user in the captured image can be protected and enhanced by himself/herself.

### DESCRIPTION OF DRAWINGS

FIG. 1 is a diagram schematically illustrating a configuration of a social-based image setting value sharing system according to a first embodiment of the present invention.

FIG. 2 is a diagram illustrating an image correction setting value registration and an application state thereof through the social-based image setting value sharing system according to the first embodiment of the present invention.

FIG. 3 is a diagram illustrating image correction steps through the social-based image setting value sharing system according to the first embodiment of the present invention.

FIG. 4 is a block diagram illustrating a configuration of an image setting value sharing application included in the social-based image setting value sharing system according to the first embodiment of the present invention.

FIG. 5 is a block diagram illustrating a configuration of an image setting value relay server included in the social-based image setting value sharing system according to the first embodiment of the present invention.

FIG. 6 is a flow chart illustrating a signal flow in the social-based image setting value sharing system according to the first embodiment of the present invention.

FIG. 7 is a diagram illustrating a grouping-based image correction setting value application state through a social-based image setting value sharing system according to a second embodiment of the present invention.

FIG. 8 is a diagram illustrating an example of grouping through the social-based image setting value sharing system according to the second embodiment of the present invention.

FIG. 9 is a flow chart illustrating a grouping-based signal flow in the social-based image setting value sharing system according to the second embodiment of the present invention.

FIG. 10 is a diagram illustrating an example of image correction in a case in which the other party is specified through a social-based image setting value sharing system according to a third embodiment of the present invention.

FIG. 11 is a diagram illustrating a data processing state for each menu of a capture mode and a pose mode using a social-based image setting value sharing system according to a fourth embodiment of the present invention.

### BEST MODE

Hereinafter, embodiments of the present invention will be described in detail with reference to the accompanying drawings.

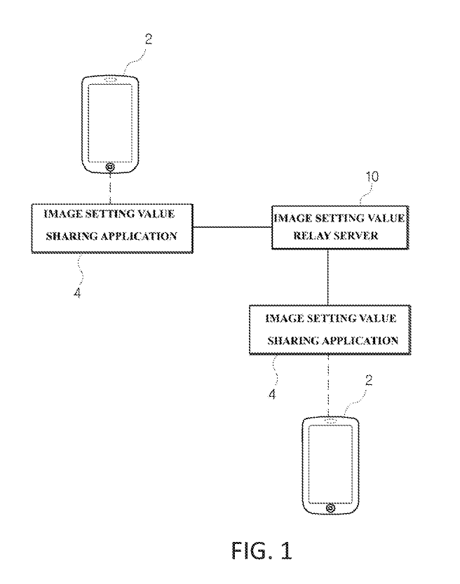

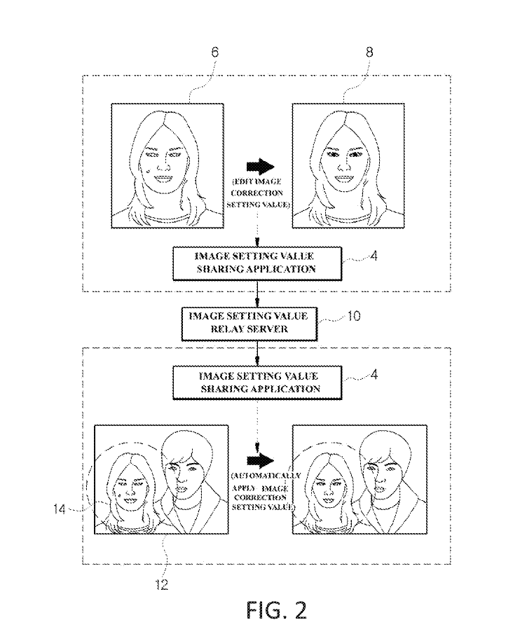

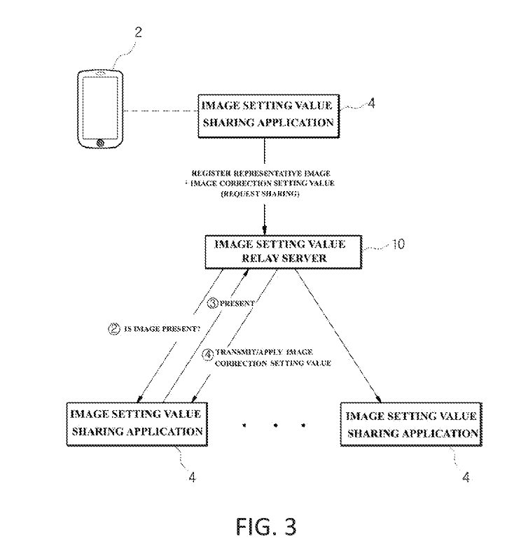

FIG. 1 is a diagram schematically illustrating a configuration of a social-based image setting value sharing system according to a first embodiment of the present invention, FIG. 2 is a diagram illustrating an image correction setting value registration and an application state thereof through the social-based image setting value sharing system according to the first embodiment of the present invention, and FIG. 3 is a diagram illustrating image correction steps through the social-based image setting value sharing system according to the first embodiment of the present invention.

Referring to FIGS. 1 to 3, the social-based image setting value sharing system according to the first embodiment of the present invention is a system in which representative portrait images for each user and image correction setting values thereof are registered in a server in advance and shared, and a portrait image of a user to be corrected through mutual information sharing among applications is tracked and automatically corrected according to the image correction setting value, such that a user's desired image may be circulated.

That is, the social-based image setting value sharing system according to the first embodiment of the present invention is a system that allows a user to automatically correct a portrait image in a picture captured by another person according to his/her own desire. In this case, the automatic correction of the image is achieved through communication between a server and applications included in the system and pre-registered image correction setting values.

To this end, the social-based image setting value sharing system according to the first embodiment of the present invention includes: a setting user terminal (‘a first user terminal’) configured to register representative image information of a person and a personal image correction setting value in an image setting value relay server 10 and request the image setting value relay server to share the image correction setting value; a user terminal to be set (‘a second user terminal’) configured to store an image file including a specific personal image, receive the image correction setting value for the specific personal image from the image setting value relay server 10 to determine whether the personal image is present in the second user terminal, and when the personal image is present, applies the image correction setting value to the personal image to perform correction thereon; and the image setting value relay server 10 configured to receive and register the representative image information of the person and the personal image correction setting value from the first user terminal, and automatically correct an image of a setting user, which is present in the second user terminal, based on the representative image according to the image correction setting value.

At this time, both the first user terminal and the second user terminal are user terminals 2, but these terminals will be described by dividing for convenience of description.

In particular, most users who have installed the image setting value sharing application 4 in the user terminals 2 may be the setting user who sets an image correction setting value, and at the same time, may be a user to be set who receives and automatically corrects an image correction setting value of another person.

On the other hand, the image correction setting value registered and shared through the social-based image setting value sharing system according to the first embodiment of the present invention is a value of at least one selected from a face, body size or face tone, or nose or pupil size, eyebrow contrast, color value, and illuminance value.

In addition, the user terminal 2 constituting the social-based image setting value sharing system according to the first embodiment of the present invention includes the image setting value sharing application 4 mounted therein to automatically access the image setting value relay server 10 to manage the representative images and the image correction setting values, search and determine whether the representative image is included in still picture or moving picture frames, and apply a specific image correction setting value to the searched representative image.

First, the social-based image setting value sharing systems according to embodiments of the present invention apply an image correction setting value which is set by a user to a portrait image of the user. Therefore, it is possible to apply the image correction setting value not only to his/her own picture file but also to a picture file taken by the third party who takes a picture of the user.

To this end, the social-based image setting value sharing systems according to the embodiments of the present invention need to scan images for determining whether the portrait image of the user is included in the picture file taken by the third party prior to sharing the image correction setting value.

Such a scan technique can be implemented in the image setting value sharing application 4 mounted in the user terminal 2, and can also be implemented in the image setting value relay server 10.

In a second embodiment illustrating an example of photo grouping in which an object to be shared is limited, it is preferable that the image setting value sharing application 4 mounted in the user terminal 2 directly executes the scanning of the images. On the other hand, in the first embodiment in which the object to be shared is not limited, the image setting value relay server 10 preferably performs the scanning of the images due to an increased calculation amount.

On the other hand, the image setting value sharing application 4 may be directly clicked and driven by the user, and may be driven and operated in conjunction with a camera module.

In this case, for example, the camera module captures a picture using a camera. However, in some cases, it is preferable that the image setting value sharing application 4 is automatically driven every time the picture file is selected on a gallery, for example, or every time the picture file is output on a screen of the user terminal through other appropriate tools.

In addition, the image setting value sharing application 4 included in the social-based image setting value sharing system according to the first embodiment of the present invention is configured to automatically identify whether the representative image is present in image files including all still picture files and moving picture files stored in the user terminal 2.

Further, the user terminals 2 having the image setting value sharing application 4 installed therein mutually share the representative image registered in advance by each user and the image correction setting value through the image setting value sharing application 4.

At this time, the representative image 6 is a representative portrait image.

In FIG. 2, there are a plurality of images including a corrected image 8 of a user, a picture image 12 of another user, and a portrait image 14 of the user in the picture of another person.

Thereby, the social-based image setting value sharing systems and methods according to the present invention may allow a user to automatically correct a portrait image in a picture captured by another person according to his/her own will and distribute the corrected image desired by the user, such that it is possible to provide confidence to the user and prevent an unfavorite image from being distributed to inhibit prejudice to the user. In addition, since the user may have a right to correct his/her own portrait in a picture of a stranger who does not know at all, privacy of the user in the captured image can be protected and enhanced by himself/herself.

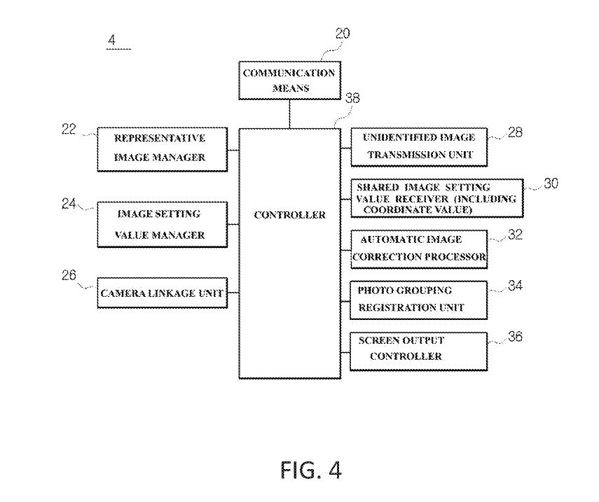

FIG. 4 is a block diagram illustrating a configuration of the image setting value sharing application included in the social-based image setting value sharing system according to the first embodiment of the present invention.

Referring to FIG. 4, the image setting value sharing application 4 provided in the social-based image setting value sharing system according to the first embodiment of the present invention includes: a communication means 20 configured to access the image setting value relay server to perform communication therewith; a representative image manager 22 configured to manage a representative image set by a user; an image setting value manager 24 configured to manage an image correction setting value which is set according to a desire for correction of the user; a shared image setting value receiver 30 configured to receive and share an image correction setting value for a specific image of a third party among still pictures or moving pictures stored in the user terminal 2; an automatic image correction processor 32 configured to automatically correct the specific image of the third party by applying the image correction setting value received through the shared image setting value receiver 30; and a controller 38 which controls so as to transmit representative image data specified by the user and a specific setting value in which a correction is set for an image matching with or similar to the representative image to the image setting value relay server 10 and register therein, receive the specific representative image and the image correction setting value from the image setting value relay server 10 to scan images from the image files stored in the user terminal, and when the matched or similar image is present, apply the image correction setting value to the image and perform the correction.

In addition, the image setting value sharing application 4 further includes a camera linkage unit 26 configured to be automatically driven and operated in conjunction with an operation signal of a camera module.

In addition, the image setting value sharing application 4 further includes an unconfirmed image transmission unit 28 configured to, when identification for a specific person among images included in the still picture files or moving picture files stored in the user terminal 2 is impossible or the image correction setting value is not present, automatically transmit the image to the image setting value relay server 10.

That is, as described above, the object to be shared of the image correction setting value is not limited in the first embodiment of the present invention. Therefore, there is no way that the image setting value sharing application 4 can confirm whether the image correction setting value is set for the specific portrait image included in the user's picture.

Accordingly, the image setting value sharing application 4 transmits an unconfirmed image to the image setting value relay server 10 by the unconfirmed image transmission unit, so as to scan and identify the image, and finally confirm whether an image correction setting value matched to the portrait image is present.

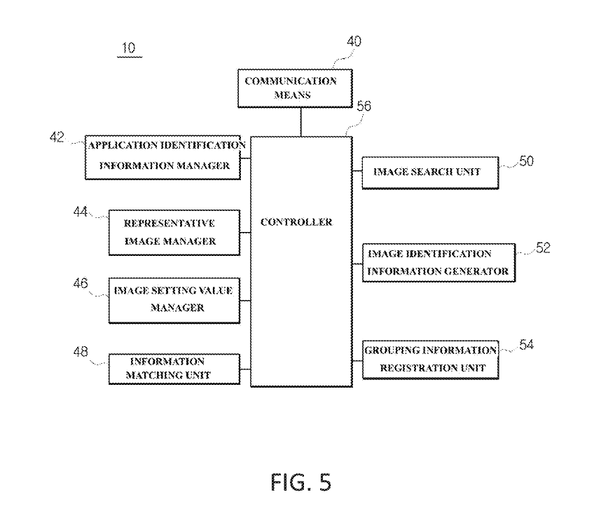

FIG. 5 is a block diagram illustrating a configuration of the image setting value relay server included in the social-based image setting value sharing system according to the first embodiment of the present invention.

Referring to FIG. 5, the image setting value relay server 10 provided in the social-based image setting value sharing system according to the first embodiment of the present invention includes: a communication means 40 configured to communicate with the first and second user terminals 2; an application identification information manager 42 configured to identify a user upon access by allocating an application code; a representative image manager 44 configured to register and manage representative images for each application; an image setting value manager 46 configured to register and manage image correction setting values for each representative portrait image; an image search unit 50 configured to receive image files from the user, and search and determine whether a specific portrait image is registered; and a controller 56 which controls so as to automatically correct his/her portrait image which is registered by the user and stored in the user terminals 2, and includes the user in the image files to a pre-set specific setting value.

Preferably, the image setting value relay server 10 further includes an information matching unit 48 configured to match application identification information, representative image information and image correction setting value information with each other.

More preferably, the image setting value relay server further includes an image identification information generator 52 configured to generate information for image identification by matching coordinate values of the portrait images included in the specific image file with the image correction setting value.

That is, when receiving the specific picture file from any one of the image setting value sharing applications 4, the image identification information generator 52 generates the information for image identification by matching the coordinate values such as an image correction setting value of a first person and an image correction setting value of a second person in an order from right to left included in the picture with the image correction setting value.

Functions and operations of the social-based image setting value sharing system according to the first embodiment of the present invention having the above-described configuration will be described in detail with reference to the accompanying drawings.

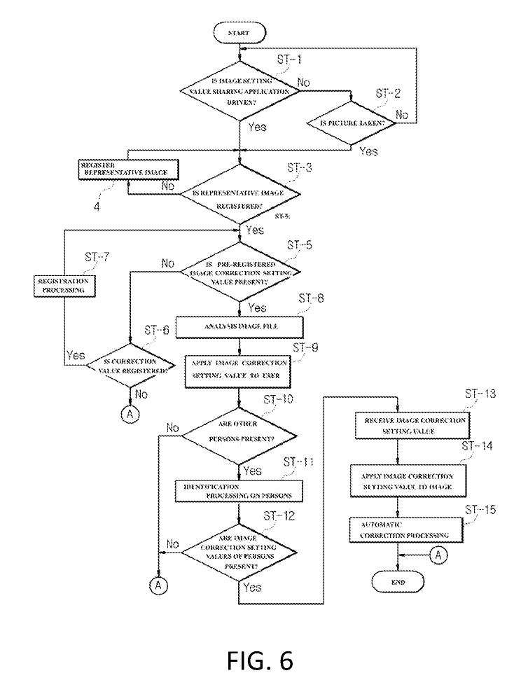

FIG. 6 is a flow chart illustrating a signal flow in the social-based image setting value sharing system according to the first embodiment of the present invention.

First, the image setting value relay server 10 included in the social-based image setting value sharing system according to the first embodiment of the present invention receives a representative portrait image and an image correction setting value of a specific user from the image setting value sharing application 4. Prior to this, the image setting value sharing application 4 is automatically driven in conjunction with an operation signal of the camera module.

The user selects and inputs the representative portrait image and image correction setting value thereof while the image setting value sharing application 4 is driven, and information thereon is transmitted to the image setting value relay server 10 by the image setting value sharing application 4.

In this state, the image setting value relay server registers the representative portrait image and the image correction setting value of the user.

Then, the image setting value sharing application 4 outputs a specific image file. If the image setting value sharing application 4 receives image correction setting values for portrait images of some acquaintances, the image setting value sharing application 4 determines whether the image correction setting values for the portrait image(s) included in the image file are present.

When the image correction setting value is present, the image setting value sharing application 4 applies the image correction setting value to the portrait image to perform the correction.

Types of the correction generally includes corrections such as slimming a face, brightening a color value, darkening eyebrows and hairs, rounding a shape of eyes, or making a prominent nose.

On the other hand, if the image correction setting value is not present, the user may operate the image setting value sharing application 4 to input an image file identification request signal. In this case, the image setting value sharing application 4 transmits the image file to the image setting value relay server 10.

Then, the image setting value relay server 10 identifies the person by comparing the portrait image included in the image file with a pre-registered representative image. At this time, it is preferable that the image setting value relay server 10 performs the corresponding process because the calculation amount is quite large in determining whether the image matches with the pre-registered image through the scanning of the images.

Next, the image setting value relay server 10 extracts image correction setting value information registered by matching with each portrait image, and the image setting value relay server 10 generates each portrait image data and coordinate information of the image, and image correction setting value information as a packet.

Thereafter, the image setting value relay server transmits the extracted image correction setting value information to the image setting value sharing application 4.

Then, the image setting value sharing application 4 automatically corrects the portrait image.

Hereinafter, a social-based image setting value sharing system according to a second embodiment of the present invention will be described in detail with reference to the accompanying drawings.

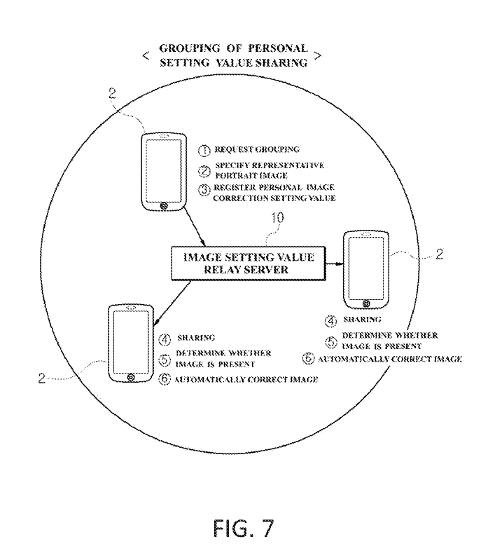

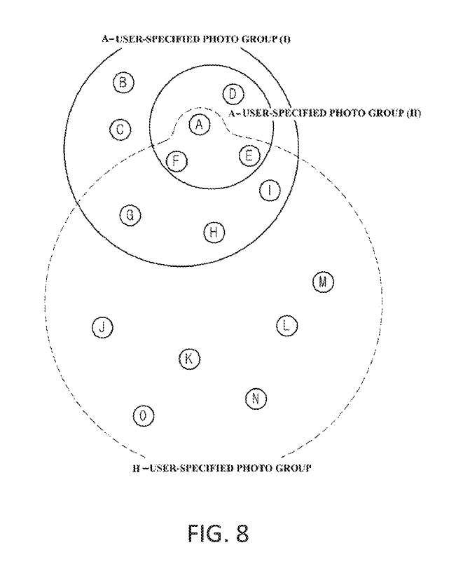

FIG. 7 is a diagram illustrating a grouping-based image correction setting value application state through the social-based image setting value sharing system according to the second embodiment of the present invention, and FIG. 8 is a diagram illustrating an example of grouping through the social-based image setting value sharing system according to the second embodiment of the present invention.

Referring to FIGS. 7 and 8, similar to the first embodiment, the social-based image setting value sharing system according to the second embodiment of the present invention also allows a specific user to correct his/her own picture file stored in a terminal thereof, as well as his/her portrait image in a picture file which is stored in or captured by a terminal of a third party to a specific correction value.

However, the social-based image setting value sharing system according to the second embodiment of the present invention is configured to limit objects that share their image correction setting values for each user by grouping in advance, and allows only the grouped objects to share their image correction setting values, thereby automatically correcting the portrait image.

Therefore, the social-based image setting value sharing system according to the second embodiment of the present invention has a significantly smaller calculation amount than the first embodiment.

In particular, since the calculation amount required to identify a person through the scanning of the images may be significantly reduced, it is desirable to automatically correct the image by the grouping.

Meanwhile, in the social-based image setting value sharing system according to the second embodiment of the present invention, the image setting value relay server 10 manages an object to be shared so that the image correction setting value registered in the image setting value relay server 10 through the first user terminal is shared by limiting to the second user terminal belonging to a photo group registered in the image setting value relay server 10 by the setting user.

In addition, the image setting value sharing application 4 further includes a photo grouping registration unit 34 configured to select a specific acquaintance based on a personal telephone directory stored in the user terminal 2 and register by grouping into a photo group, and allow the image correction setting values to be shared only within the photo group.

Preferably, any one setting user may be simultaneously registered in a plurality of photo groups.

In addition, the image setting value relay server 10 further includes a grouping information registration unit 54 configured to select a specific acquaintance based on the personal telephone directory stored in the user terminal 2 and register the same by grouping into a photo group so that the image correction setting value is shared only within the photo group.

Functions and operations of the social-based image setting value sharing system according to the second embodiment of the present invention having the above-described configuration will be described in detail with reference to the accompanying drawings.

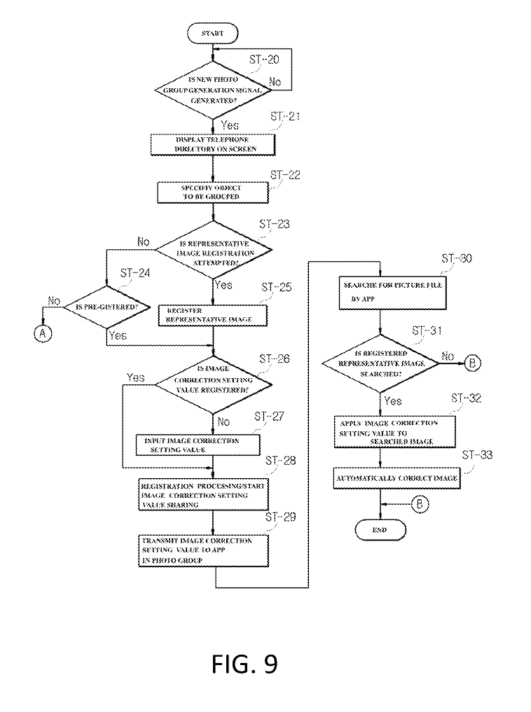

FIG. 9 is a flow chart illustrating a grouping-based signal flow in the social-based image setting value sharing system according to the second embodiment of the present invention.

First, in the social-based image setting value sharing system according to the second embodiment of the present invention, a user generates a key operation signal for generating a new photo group through the image setting value sharing application 4.

Then, the image setting value sharing application 4 calls and outputs a previously-linked telephone directory, such that the user may select an object to be grouped from the personal telephone directory through the image setting value sharing application 4.

Thereby, when receiving a new photo group generation request signal by the image setting value relay server 10 from the image setting value sharing application 4 of a specific user, the image setting value relay server 10 generates a new photo group.

Next, the image setting value relay server 10 receives a representative portrait image and an image correction setting value from the image setting value sharing application 4 of a specific user.

Then, the image setting value relay server 10 registers the representative portrait image and the image correction setting value of the user.

Thereafter, the image setting value relay server 10 transmits the representative portrait image and the image correction setting value of the user to the user terminal 2 specified by the grouping, and the shared image setting value sharing application 4 of the other user who shares the image correction setting value searches whether a portrait image matching with the representative portrait image of the user is present.

When the matched portrait image is present, the image setting value sharing application 4 applies the image correction setting value of the user to the image and performs the correction.

Hereinafter, a social-based image setting value sharing system according to a third embodiment of the present invention will be described in detail with reference to the accompanying drawings.

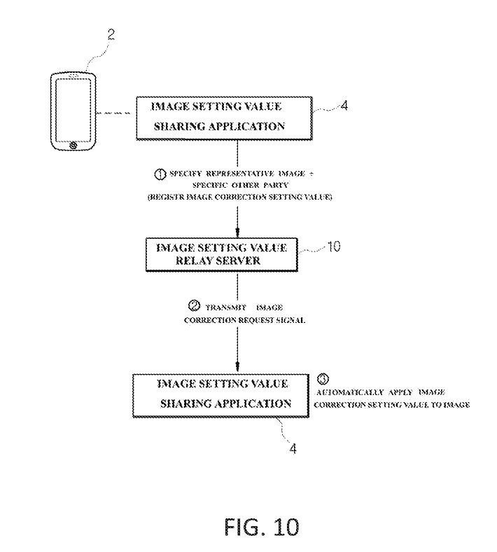

FIG. 10 is a diagram illustrating an example of image correction in a case in which the other party is specified through the social-based image setting value sharing system according to the third embodiment of the present invention.

Referring to FIG. 10, the third system assumes a situation in which the grouping of the second embodiment is limited to two persons. In order to guarantee privacy of lovers after separation, this system has an object to automatically correct a portrait image of a user in a picture file captured with a lover in the past to a portrait image of another person, or a portrait image of an unidentifiable person.

Therefore, the social-based image setting value sharing system according to the third embodiment of the present invention is a system which performs the correction so as to limit the number of new photo groups to two persons, and replace a specific portrait image with another portrait image. Except for these characteristics, the remaining configurations, functions and operations of the third embodiment are the same as those of the second embodiment, and therefore will not be described.

Hereinafter, a social-based image setting value sharing system according to a fourth embodiment of the present invention will be described in detail with reference to the accompanying drawings.

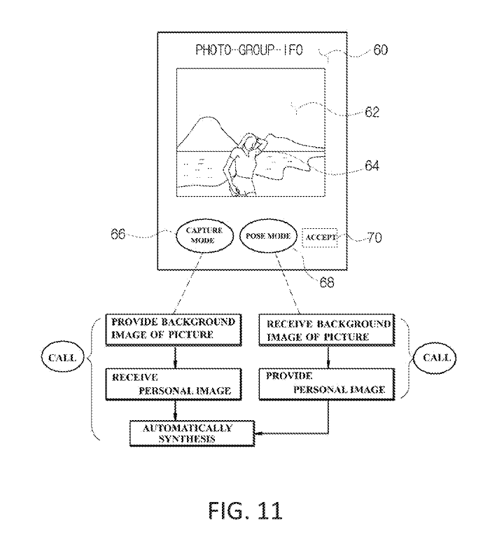

FIG. 11 is a diagram illustrating a data processing state for each menu of a capture mode and a pose mode using the social-based image setting value sharing system according to the fourth embodiment of the present invention.

Referring to FIG. 11, the image setting value sharing application 4 provided in the social-based image setting value sharing system according to the fourth embodiment of the present invention further includes a screen output controller 36 which controls so as to insert a portrait image provided by the other party into a background image captured by a user in the capture mode and output on a screen, and insert his/her portrait image captured by the user into a background image provided by the other party and output on the screen in the pose mode.

Therefore, in the social-based image setting value sharing system according to the fourth embodiment of the present invention, any user of two users located in different spaces at the same time may select the capture mode through the image setting value sharing application 4, and the other user may select the pose mode.

In this state, the image setting value sharing application 4 of the user captures a background image in conjunction with the camera.

Then, the image setting value sharing application 4 of the user outputs a background image on the screen.

At this time, the image setting value sharing application 4 of the other user receives the background image file from the image setting value sharing application 4 of the user, and outputs the received background image file on the screen.

Then, the image setting value sharing application 4 of the other user captures a portrait image and automatically inserts it into the background image.

The image file in which the portrait image is inserted is shared between the image setting value sharing applications 4.

In the above-described social-based image setting value sharing system according to the fourth embodiment of the present invention, for example, a first user may request to capture a picture to a terminal 2 of a second user located in different spaces at the same time zone while touring a scenic spot in an overseas country. At this time, when a second user accepts the capturing request, the second user may take a picture in real time as if the first user came to the scenic spot in the overseas country where the second user is touring.

To this end, the second user transmits his/her captured portrait image to the image setting value sharing application 4 of the first user through the image setting value sharing application 4 thereof, and the image setting value sharing application 4 of the first user transmits the background image captured by him/her to the image setting value sharing application 4 of the second user, thereby allowing an insertion of a portrait image into the background image.

When an edition of the background and the portrait image is completed in the image setting value sharing application 4 of any one user, both the first and second users may share the image file in which the portrait image is included together with the background.

Preferably, the social-based image setting value sharing system according to the fourth embodiment of the present invention is capable of making a voice call while performing the above-described function, such that the user may advise about the pose of the other party.

Meanwhile, the social-based image setting value sharing systems and methods according to the embodiments of the present invention are not limited to the above described first to fourth embodiments, but may be variously modified without departing from the technical gist of the present invention.

### DESCRIPTION OF REFERENCE NUMERALS

2: User terminal

4: Image setting value sharing application

10: Image setting value relay server

22: Representative image manager

24: Image setting value manager

26: Camera linkage unit,

32: Image automatic correction processor

34: Photo grouping registration unit

1. A social-based image setting value sharing system comprising:
a setting user terminal (‘first user terminal’) configured to register representative image information of a person and a personal image correction setting value in an image setting value relay server and request the image setting value relay server to share the image correction setting value;
a user terminal to be set (‘a second user terminal’) configured to store an image file including a specific personal image, receive the image correction setting value for the specific personal image from the image setting value relay server to determine whether the personal image is present in the second user terminal, and when the personal image is present, applies the image correction setting value to the personal image to perform correction thereon; and
the image setting value relay server configured to receive and register the representative image information of the person and the personal image correction setting value from the first user terminal, and automatically correct an image of a setting user, which is present in the second user terminal, based on the representative image according to the image correction setting value.

2. The social-based image setting value sharing system according to claim 1, wherein the image correction setting value is a value of at least one selected from a face, body size or face tone, or nose or pupil size, eyebrow contrast, color value, and illuminance value.

3. The social-based image setting value sharing system according to claim 1, wherein the first user terminal and the second user terminal respectively comprise: an image setting value sharing application mounted therein to automatically access the image setting value relay server to manage the representative images and the image correction setting values, search and determine whether the representative image is included in still picture or moving picture frames, and apply a specific image correction setting value to the searched representative image.

4. (canceled)

5. The social-based image setting value sharing system according to claim 3, wherein the image setting value sharing application is configured to automatically identify whether the representative image is present in image files including all still picture files and moving picture files stored in a user terminal.

6. The social-based image setting value sharing system according to claim 3, wherein the image setting value sharing application comprises:
a communication means configured to access the image setting value relay server to perform communication therewith;
a representative image manager configured to manage a representative image set by a user;
an image setting value manager configured to manage an image correction setting value which is set according to a desire for correction of the user;
a shared image setting value receiver configured to receive and share an image correction setting value for a specific image of a third party among still pictures or moving pictures stored in the user terminal;
an automatic image correction processor configured to automatically correct the specific image of the third party by applying the image correction setting value received through the shared image setting value receiver; and
a controller which controls so as to transmit representative image data specified by the user and a specific setting value in which a correction is set for an image matching with or similar to the representative image to the image setting value relay server and register therein, receive the specific representative image and the image correction setting value from the image setting value relay server to scan images from the image files stored in the user terminal, and when the matched or similar image is present, apply the image correction setting value to the image and perform the correction.

7. (canceled)

8. The social-based image setting value sharing system according to claim 3, wherein the image setting value sharing application further comprises: an unconfirmed image transmission unit configured to, when identification for a specific person among images included in still picture files or moving picture files stored in the user terminal is impossible or the image correction setting value is not present, automatically transmit the image to the image setting value relay server.

9. The social-based image setting value sharing system according to claim 3, wherein the image setting value sharing application further comprises: a photo grouping registration unit configured to select a specific acquaintance based on a personal telephone directory stored in the user terminal and register by grouping into a photo group, and allow the image correction setting values to be shared only within the photo group.

10. The social-based image setting value sharing system according to claim 3, wherein the image setting value sharing application further comprises: a screen output controller which controls so as to insert a portrait image provided by the other party into a background image captured by a user in a capture mode and output on a screen, and insert his/her portrait image captured by the user into a background image provided by the other party and output on the screen in a pose mode.

11. The social-based image setting value sharing system according to claim 3, wherein the user terminals having the image setting value sharing application installed therein mutually share the representative image registered in advance by each user with the image correction setting value through the image setting value sharing application.

12. (canceled)

13. The social-based image setting value sharing system according to claim 1, wherein the image setting value relay server manages an object to be shared so that the image correction setting value registered in the image setting value relay server through the first user terminal is shared by limiting to the second user terminal belonging to a photo group registered in the image setting value relay server by the setting user.

14. The social-based image setting value sharing system according to claim 1, wherein any one setting user is simultaneously registered in a plurality of photo groups.

15. The social-based image setting value sharing system according to claim 1, wherein any one setting user specifies a specific user to be set 1:1 so as to change or correct his/her portrait image to a specific image.

16. The social-based image setting value sharing system according to claim 1, wherein the image setting value relay server comprises:
a communication means configured to communicate with first and second user terminals;
an application identification information manager configured to identify a user upon access by allocating an application code;
a representative image manager configured to register and manage representative images for each application;
an image setting value manager configured to register and manage image correction setting values for each representative portrait image;
an image search unit configured to receive image files from a user, and search and determine whether a specific portrait image is registered; and
a controller which controls so as to automatically correct his/her portrait image which is registered by the user and stored in the user terminals, and includes the user in the image files to a pre-set specific setting value.

17. The social-based image setting value sharing system according to claim 1, wherein the image setting value relay server further comprises: an information matching unit configured to match application identification information, representative image information and image correction setting value information with each other.

18. The social-based image setting value sharing system according to claim 1, wherein the image setting value relay server further comprises: an image identification information generator configured to generate information for image identification by matching coordinate values of the portrait images included in the specific image file with the image correction setting value.

19. The social-based image setting value sharing system according to claim 1, wherein the image setting value relay server further comprises: a grouping information registration unit configured to select a specific acquaintance based on a personal telephone directory stored in a user terminal and register the same by grouping into a photo group so that the image correction setting value is shared only within the photo group.

20. (canceled)

21. (canceled)

22. (canceled)

23. (canceled)

24. A social-based image setting value sharing method, comprising:
a) receiving a new port group generation request signal from an image setting value sharing application of a specific user, by an image setting value relay server;
b) generating a new photo group by the image setting value relay server;
c) receiving a representative portrait image and an image correction setting value from the image setting value sharing application of the specific user;
d) registering the representative portrait image and the image correction setting value of the user, by the image setting value relay server;
e) transmitting the representative portrait image and the image correction setting value of the user to a user terminal specified by grouping, by the image setting value relay server;
f) searching for a portrait image matched with the representative portrait image of the user, by the shared image setting value sharing application; and
g) when a portrait image file matched with the representative portrait image is searched, applying the image correction setting value of the user to the portrait image to perform correction thereon, by the image setting value sharing application.

25. The social-based image setting value sharing method according to claim 24, further comprising: before the step a),
receiving a new photo group generation key operation signal by the image setting value sharing application;
calling and outputting a linked telephone directory by the image setting value sharing application; and
specifying an object to be grouped by the image setting value sharing application.

26. The social-based image setting value sharing method according to claim 24, wherein the step a) further comprises: performing the correction so as to limit the new photo group to two persons and replace a specific portrait image with another portrait image.

27. A social-based image setting value sharing method, comprising:
a) selecting a capture mode through an image setting value sharing application by any user of two users located in different spaces at the same time, and selecting a pose mode by the other user;
b) capturing a background image in conjunction with a camera by the image setting value sharing application;
c) outputting the background image on a screen by the image setting value sharing application 4;
d) receiving a background image file from the image setting value sharing application 4 of the user, and outputting the received background image file on the screen, by the image setting value sharing application of the other user;
e) capturing a portrait image and automatically inserting it into the background image, by the image setting value sharing application of the other user; and
f) sharing an image file in which the portrait image is inserted between the image setting value sharing applications.
